(19) United States
(12) Patent Application Publication
(10) Pub. No.: US 2017/0113118 A1
(43) Pub. Date: Apr. 27, 2017

(54) Snow Sled Leg Apparatus And Method Of Use Thereof

(71) Applicant: Sled Legs, LLC, Holland, MI (US)

(72) Inventor: Richard J. Michaels, III, Holland, MI (US)

(21) Appl. No.: 15/331,973

(22) Filed: Oct. 24, 2016

Related U.S. Application Data
(60) Provisional application No. 62/246,284, filed on Oct. 26, 2015.

(51) Int. Cl. A63C 5/00; B62B 13/06; A63C 9/00

(52) U.S. Cl. CPC A63C 5/003; A63C 9/002; B62B 13/06

(57) ABSTRACT

A sled leg for a sled leg apparatus that has a sled body and a user attachment structure. The sled body has a base with an upper surface and lower surface, a nose and a tail. The nose includes an upwardly inclined portion. The lower surface is structurally configured to slide along an outside surface of relatively low friction. The upper surface is structurally configured to receive a shin of a user. The user attachment structure extends from opposing sides of the sled body. The user attachment structure is structurally configured to sandwich a leg of a user between the user attachment structure and the sled body, to, in turn, maintain the sled body in the desired position.

### CROSS-REFERENCE TO RELATED APPLICATION

This application claims priority from U.S. Pat. App. Ser. No. 62/246,284 filed Oct. 26, 2016, entitled “Snow Sled Legs,” the entire specification of which is hereby incorporated by reference in its entirety.

### BACKGROUND OF THE DISCLOSURE

1. Field of the Disclosure

The disclosure relates in general to an outdoor recreational device, and more particularly, to a sledding device for outside surfaces of low friction, such as snow hills and the like.

2. Background Art

Sledding or other like activities have been done for generations on snowy hills worldwide. Typically, a sled, toboggan, inner tube, saucer or other device is placed on the ground at an elevated part of a hill. The user then steps onto the device and due to the low friction, the user slides down the hill. Once at the bottom, the user can carry the device up the hill again to repeat the process.

Problematically, such devices may be cumbersome and heavy. It is often difficult for a user to return to the elevated portion of the hill with the device. Many times, multiple users are required to carry the device. In other cases, especially with younger users, an older user, or a parent must help carry the device. Furthermore, it is often difficult to carry or otherwise deliver the device to the hill in the initial instance. For example, a user may have to bring the device from home which may be quite a distance away. In addition, many times, it may be difficult to transport such devices.

Accordingly, it is desirable to provide a device which can overcome at least some of these problems, as well as provide additional utility.

### SUMMARY OF THE DISCLOSURE

The disclosure is directed a sled leg for a sled leg apparatus that comprises a sled body and a user attachment structure. The sled body has a base with an upper surface and lower surface, a nose and a tail. The nose includes an upwardly inclined portion. The lower surface is structurally configured to slide along an outside surface of relatively low friction. The upper surface is structurally configured to receive a shin of a user thereover. The user attachment structure extends from opposing sides of the sled body. The user attachment structure is structurally configured to sandwich a leg of a user between the user attachment structure and the sled body, to, in turn, maintain the sled body in the desired position.

In some configurations, the sled body further includes a first side upstanding wall and a second side upstanding wall spaced apart from the first side upstanding wall. Each of the first and second side upstanding walls extending between the nose and the tail of the base so as to define a channel, with the user attachment structure interfacing at a first end with the first side upstanding wall and at a second end with the second side upstanding wall.

In some configurations, the sled body includes a front strap coupling assembly and a back strap coupling assembly. The user attachment structure comprises a front strap coupled to the front strap coupling assembly and a back strap coupled to the back strap coupling assembly.

In some configurations, the front strap coupling assembly comprises a plurality of openings on the first side upstanding wall which correspond to a plurality of openings on the second side upstanding wall.

In some configurations, the front strap includes a first end coupled to the front strap coupling assembly through a first fastener and a second end coupled to the front strap coupling assembly through a second fastener. The front strap includes a length adjustment structure.

In some configurations, the back strap coupling assembly comprises a plurality of openings on the first side upstanding wall which correspond to a plurality of openings on the second side upstanding wall. The front strap coupling assembly is spaced apart from the back strap coupling assembly.

In some configurations, the lower surface of the base includes a plurality of ridges that extend generally parallel to the channel and between the nose and tail thereof.

In some configurations, an inner sled pad is positioned within the channel of the sled body. The inner sled pad includes an outward surface structurally configured to receive the shin of the user and a sled body facing surface overlying the inner surface of the base and an inner surface of each of the first side upstanding wall and second side upstanding wall.

In some configurations, the inner sled pad is one of adhered, thermally bonded and mechanically fastened to the sled body.

In some configurations, the inner sled pad is softer than the sled body.

In some configurations, the outward surface of the inner sled pad includes a central portion, with a first side ledge to one side thereof and a second side ledge to a second side thereof.

In some configurations, a forward region is proximate the nose and a tail region is proximate the tail. The forward region and the tail region meet between the nose and the tail, with the forward region being thinner than the tail region.

In some configurations, the forward region is wider than the tail region.

In some configurations, the inner sled pad comprises a closed cell foam.

In another aspect of the disclosure, the disclosure is directed to a snow sled leg apparatus comprising a pair of sled legs. Each sled leg comprises sled body and a user attachment structure. The sled body has a base with an upper surface and lower surface, a nose and a tail. The nose includes an upwardly inclined portion. The lower surface is structurally configured to slide along an outside surface of relatively low friction. The upper surface is structurally configured to receive a shin of a user thereover. An inner sled pad is positioned within the channel of the sled body. The inner sled pad includes an outward surface structurally configured to receive the shin of the user and a sled body facing surface overlying the inner surface of the base and an inner surface of each of a first side upstanding wall and a second side upstanding wall which extend upwardly from the upper surface of the sled body on opposing sides thereof. The user attachment structure extends from opposing sides of the sled body. The user attachment structure is structurally configured to sandwich a leg of a user between the user attachment structure and the sled body, to, in turn, maintain the sled body in the desired position.

In yet another aspect of the disclosure, the disclosure is directed to a method of using a snow sled leg apparatus. The method comprises the steps of: providing a first sled leg and a second sled leg, each sled leg having a sled body and a user attachment structure coupled to the sled body; positioning a first lower leg of a user over an upper surface of the sled body of the first sled leg; sandwiching the first lower leg of a user between the sled body and the user attachment structure of the first sled leg to releasably couple the first lower leg thereto; positioning a second lower leg of the user over an upper surface of the sled body of the second sled leg, thereby placing the same in an operable configuration; sandwiching the second lower leg of a user between the sled body and the user attachment structure of the second sled leg to releasably couple the second lower leg thereto, thereby placing the same in an operable configuration; kneeling on an outside surface of relatively low friction so as to place a lower surface of the sled body of each of the first and second sled legs on the outside surface; and sliding along the outside surface on the lower surface of the sled body of each of the first and second sled legs.

In some configurations, the method further comprises the step of standing up after the step of sliding; and walking while maintaining the first sled leg and the second sled leg in the operable configuration.

In some configurations, the first sled leg and the second sled leg do not interfere with either the knee or the ankle when in the operable configuration.

In some configurations, the step of sliding further comprises the step of: shifting weight of the user to effectuate a change in direction while sliding.

### BRIEF DESCRIPTION OF THE DRAWINGS

The disclosure will now be described with reference to the drawings wherein:

FIG. 1 of the drawings is a perspective view of both of the snow sled legs of snow sled leg apparatus;

FIG. 2 of the drawings is a front, top perspective view of one of the snow sled legs of the snow sled apparatus of the present disclosure;

FIG. 3 of the drawings is a back, top perspective view of one of the snow sled legs of the snow sled apparatus of the present disclosure;

FIG. 4 of the drawings is a top plan view of one of the snow sled legs of the snow sled apparatus of the present disclosure;

FIG. 5 of the drawings is a cross-sectional view of one of the snow sled legs of the snow sled apparatus of the present disclosure;

FIG. 6 of the drawings is a bottom plan view of one of the snow sled legs of the snow sled apparatus of the present disclosure;

FIG. 7 of the drawings is a top, front perspective view of the sled body of one of the snow sled legs of the snow sled apparatus of the present disclosure;

FIG. 8 of the drawings is a top, back perspective view of the sled body of one of the snow sled legs of the snow sled apparatus of the present disclosure;

FIG. 9 of the drawings is a bottom, front perspective view of the sled body of one of the snow sled legs of the snow sled apparatus of the present disclosure;

FIG. 10 of the drawings is a front, top perspective view of the inner sled pad of one of the snow sled legs of the snow sled apparatus of the present disclosure;

FIG. 11 of the drawings is a back, top perspective view of the inner sled pad of one of the snow sled legs of the snow sled apparatus of the present disclosure;

FIG. 12 of the drawings is a front, bottom perspective view of the inner sled pad of one of the snow sled legs of the snow sled apparatus of the present disclosure;

FIG. 13 of the drawings is a cross-sectional view of one of the snow sled legs of the snow sled apparatus of the present disclosure, showing, in particular, the front strap and front strap coupling of the user attachment structure of one of the sled legs of the snow sled leg apparatus of the present disclosure, and taken generally about lines 13-13 of FIG. 4;

FIG. 14 of the drawings is a cross-sectional view of one of the snow sled legs of the snow sled apparatus of the present disclosure, showing, in particular, the back strap and back strap coupling of the user attachment structure of one of the sled legs of the snow sled leg apparatus of the present disclosure, and taken generally about lines 14-14 of FIG. 4;

FIG. 15 of the drawings is a partial side elevational view of a user walking with the snow sled leg apparatus placed on the user's legs in an operable configuration; and

FIG. 16 of the drawings is a top plan view of a user kneeling on the snow sled leg apparatus in an operating and sledding configuration.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

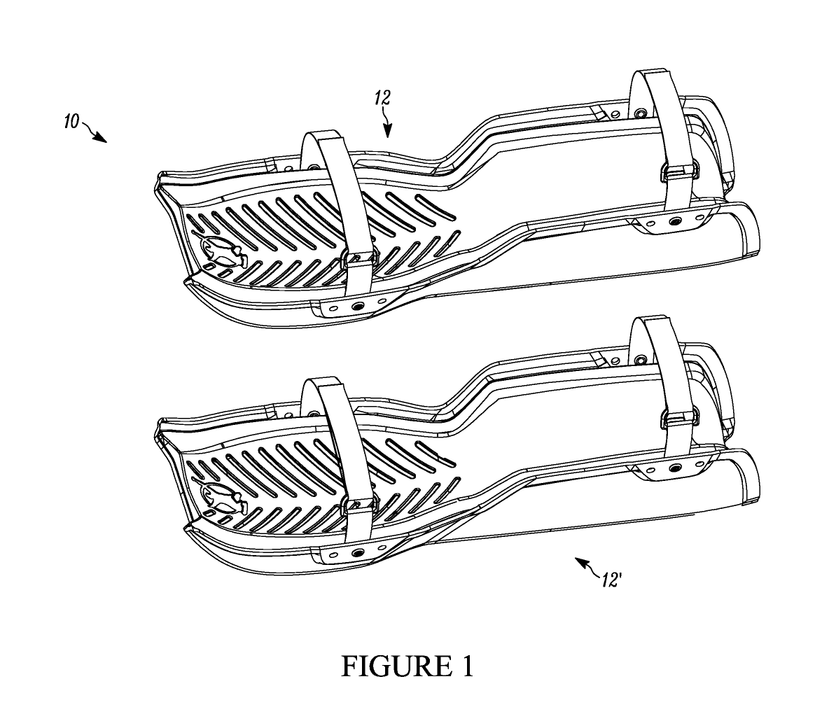

Referring now to the drawings and in particular to FIG. 1, the snow sled leg apparatus of the present disclosure is shown generally at 10. The apparatus is formed from a pair of sled legs, 12, 12′. It will be understood, and explained further below with respect to the method, that the pair of sled legs are attached to a user and then utilized together to slide down a snow hill. Advantageously, the user can then stand up and walk back up the hill without removing the sled legs and without having the sled legs hampering, impairing or otherwise negatively impacting walking.

It will be understood that in the configuration shown, the first sled leg and the second sled leg are identical in configuration. Essentially, two identical sled legs comprise the snow sled leg apparatus, as shown. It will be understood that the apparatus is not limited to such a configuration. In particular, in some configurations of the apparatus, the two sled legs may comprise different configurations. For example, in some such configurations, the sled legs may be mirror images of each other, and, in such a configuration, the sled legs may be marked “L” or “R” denoting use on a left or right leg. In still other configurations, the two legs may be completely different in configuration. Among other differences, the differences may be ornamental, or additional functionality may be afforded due to the differences. Even through one sled leg configuration will be described in detail below, it will be understood that the disclosure is not limited to the particular configuration, or two identical sled legs having the same configuration.

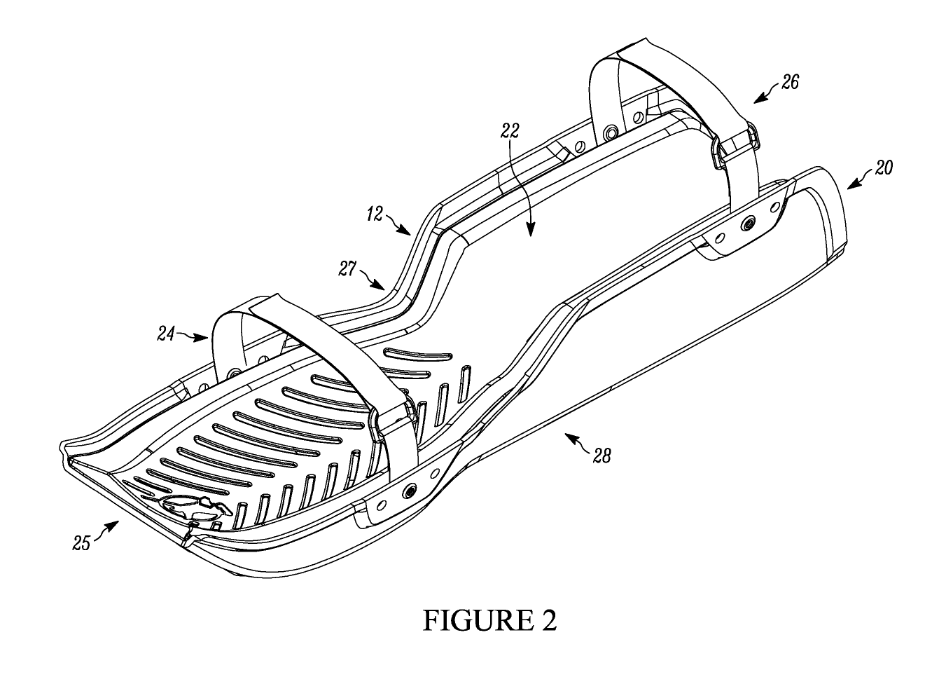

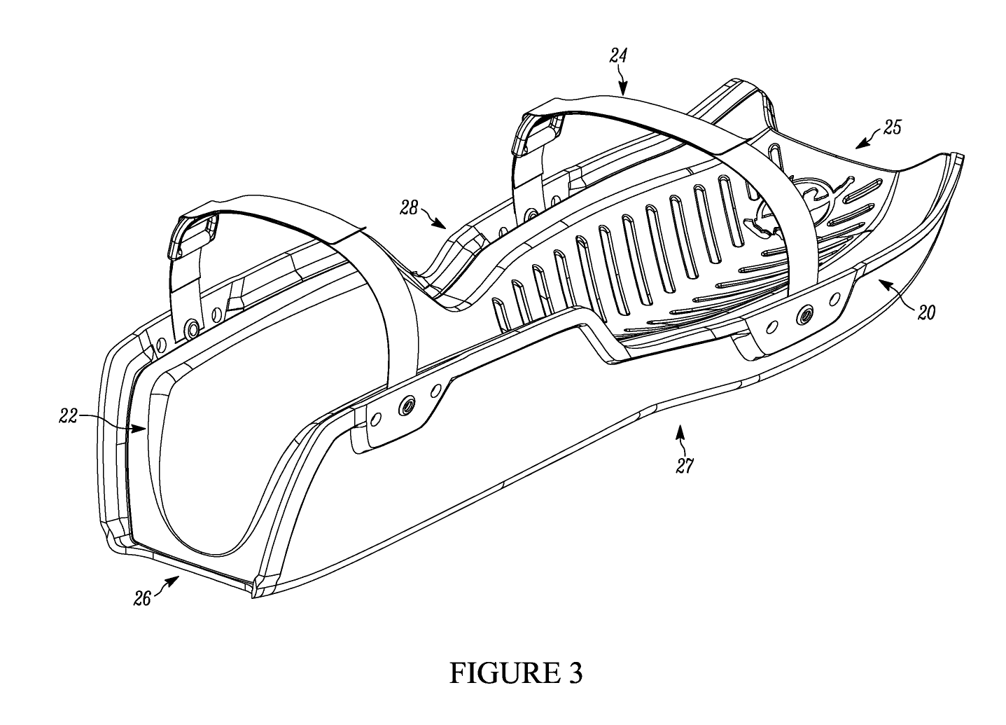

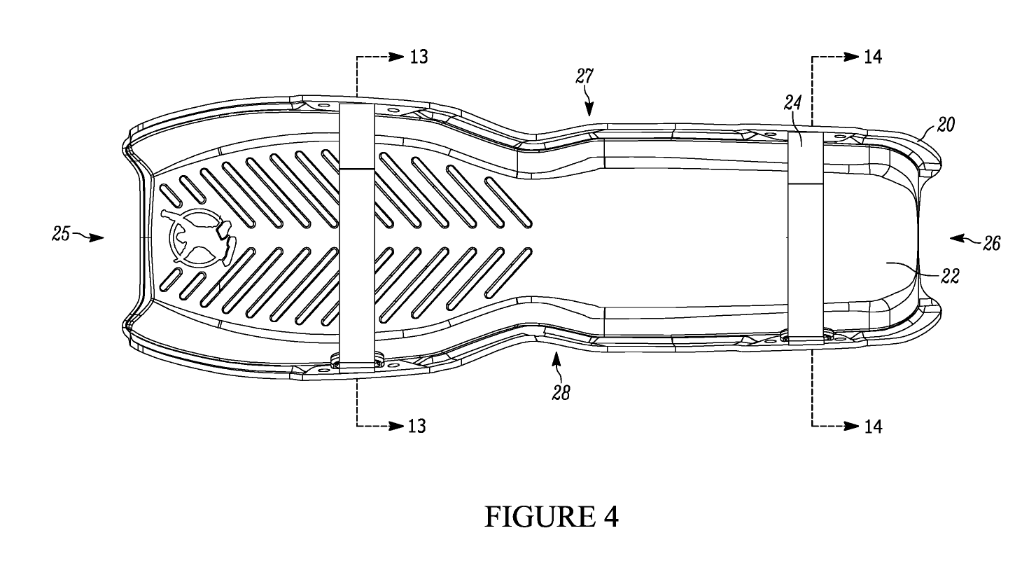

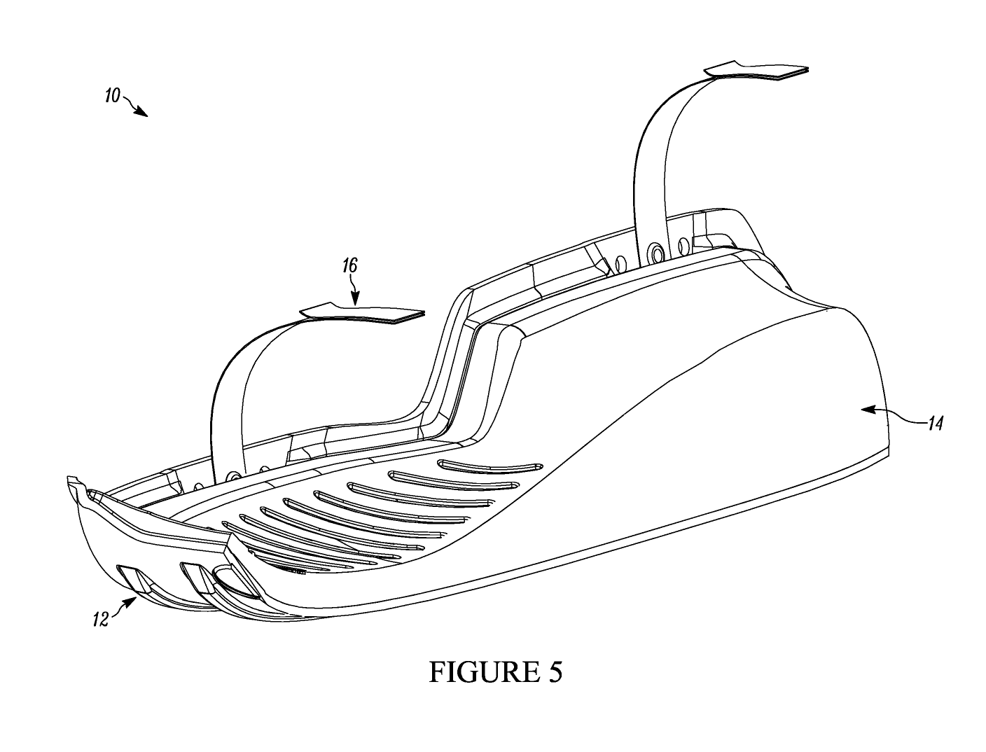

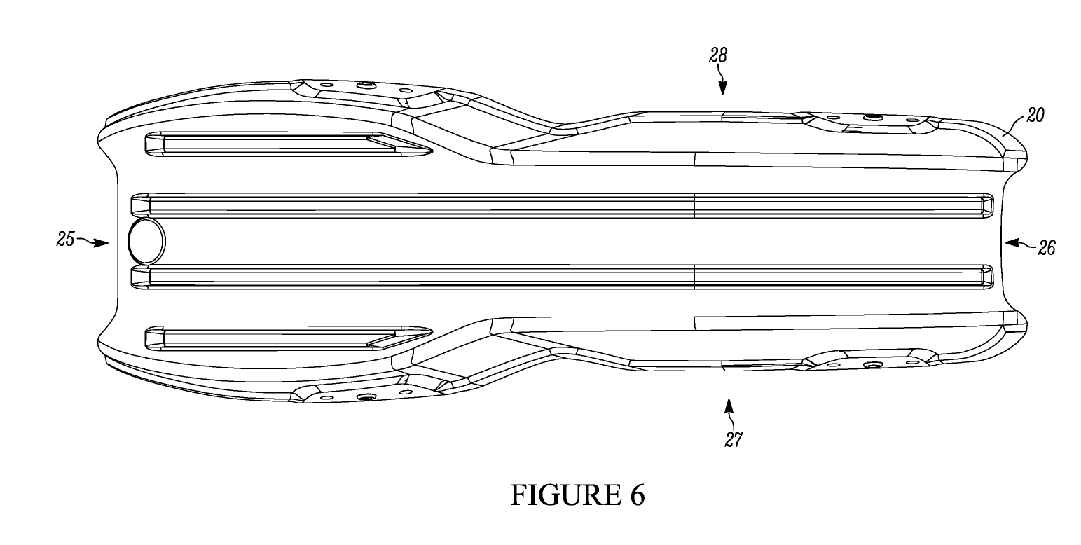

With further reference to FIGS. 2 through 6, one sled leg will be described, with the understanding, as set forth above, the other sled leg may have the same, similar or functionally similar or identical configurations. As such, the one sled leg has been isolated for explanation. As is shown in FIGS. 2 through 6, the sled leg 12 includes sled body 20, inner sled pad 22 and user attachment structure 24. The sled leg generally defines a front 25, back 26, first side 27 and second side 28. It will be understood that when in use, the front generally faces downhill with the back trailing behind, and with the opposing first side and second side positioned on either side of a user's lower leg so as to straddle the leg. Further, it will be understood that the front is positioned proximate the knee area, with the back positioned proximate the ankle area.

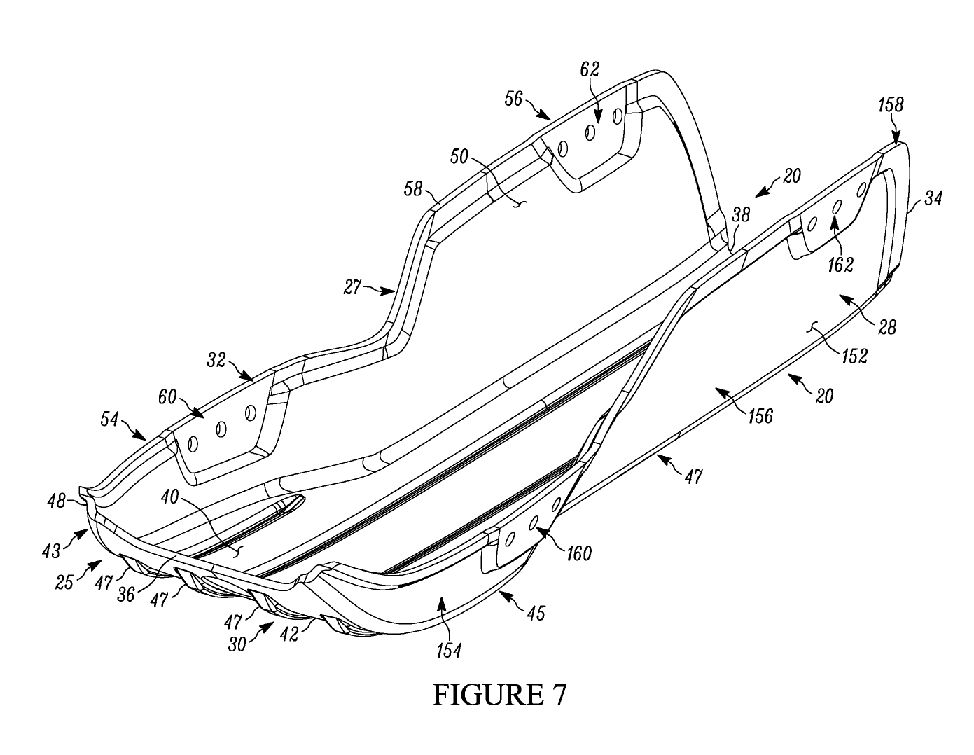

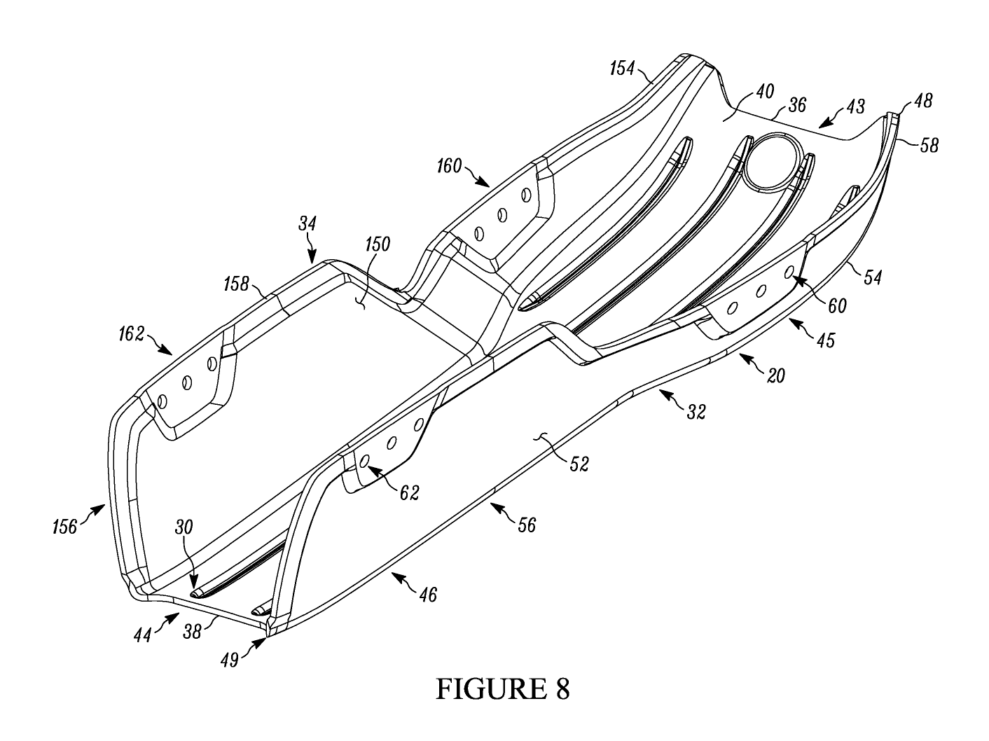

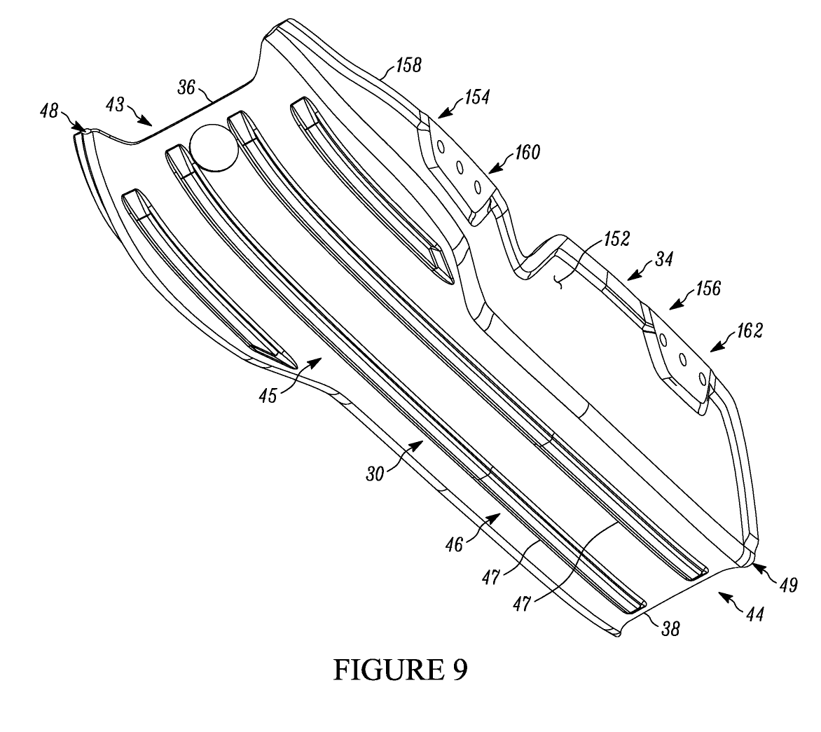

The sled body 20 is shown in greater detail in FIGS. 7 through 9. The sled body includes base 30, first side upstanding wall 32 and second side upstanding wall 34, that cooperatively define a channel in a longitudinal direction (i.e., the general direction of travel of the sled legs when in use). In the configuration shown, the sled body comprises a single integrally formed member, although variations and multiple components is contemplated. In one configuration, the base comprises a polymer, such as HDPE or the like. In some configurations, the base may be thermoformed, blow molded, and/or injection molded, for example. In other configurations, the base may comprise a wood member, or a metal member, a composite member (such as a composite formed from wood and metal, and/or a composite formed from a plurality of fibers embedded within a resin matrix), or combinations of the foregoing, including combinations with polymers. In some configurations, the sled body may be flexible, so as to be able to bend with the user's legs, knees and ankles. In other configurations, it is contemplated that additional shielding or flexible covers may be positioned so as to shield the foot during operation.

The base 30 of the sled body 20 includes upper surface 40, lower surface 42 that extend from the nose 43 to the tail 44. The upper surface 40 and lower surface 42 cooperatively define outwardly facing ridges 47 that extend outwardly from the lower surface 42. The nose 43 includes a leading edge 36 that is defined by a central depression defining opposing side wings 48. The leading edge and the nose portion are inclined upwardly so as to facilitate gliding over the snow, and through the snow or otherwise along a relatively low friction surface and over any obstacles. The leading edge 36 is configured to generally minimize intrusion proximate the knee of a user. The tail 44 includes a trailing edge 38 that is defined by a central depression and opposing side wings 49. The trailing edge 38 is configured to generally minimize intrusion proximate the ankle and foot of a user. The base 30 has a forward region 45 and a tail region 46, and the space between the nose and the tail is substantially planar (apart from longitudinally running ridges), preferably, so as to allow for smooth unimpeded travel along the outside surface. The forward region 45 is generally wider than the tail region, and, at a transition region therebetween the base narrows from the forward region to the tail region by meeting thereat, again, generally following the contours of the lower leg of a user, and also the greater width provides enhanced knee support.

The first side upstanding wall 32, and the second side upstanding wall 34 extend upwardly from opposing sides of the base 30 and are generally mirror images of each other. The first side upstanding wall 32 includes inner surface 50, outer surface 52, forward region 54 and tail region 56. An upper edge 58 is defined. In the configuration shown, the height of the first upstanding wall is greater in the tail region than at the forward region. The first upstanding wall may include a frame region that is bowed outwardly along the perimeter of thereof.

The first side upstanding wall 32 further includes front strap coupling assembly 60 positioned proximate the upper edge 58 along the forward region. The front strap coupling assembly is configured to engage the front strap and couple with the front strap. A number of different configurations are contemplated. In the configuration shown, the front strap coupling assembly comprises a plurality of substantially circular openings that are configured to receive a fastener therethrough. The particular opening that is utilized can be varied depending on the length of the leg portions of the user. In other configurations, different structures are contemplated, such as a single opening, a snap or other coupling portion, as well as other structures to which a user attachment structure can be mated.

A back strap coupling assembly 62 is likewise positioned on the first side upstanding wall 32 proximate the upper edge 58 along the tail region. As with the front strap coupling assembly, a number of different structures are contemplated for use. In the configuration shown, again, much like the front strap coupling assembly, the back strap coupling assembly comprises a plurality of substantially circular openings that are configured to receive a fastener therethrough. It will be understood that depending on the configuration, the front and back strap coupling assemblies may be the same or different from each other.

The second side upstanding wall 34 includes inner surface 150, outer surface 152, forward region 154, and tail region 156. An upper edge 158 is defined. In the configuration shown, the height of the second upstanding wall is greater in the tail region than at the forward region. The second upstanding wall may include a frame region that is bowed outwardly along the perimeter of thereof.

The second side upstanding wall 34 further includes front strap coupling assembly 160 positioned proximate the upper edge 158 along the forward region. The front strap coupling assembly is configured to engage the front strap and couple with the front strap. A number of different configurations are contemplated. In the configuration shown, the front strap coupling assembly comprises a plurality of substantially circular openings that are configured to receive a fastener therethrough. The particular opening that is utilized can be varied depending on the length of the leg portions of the user. In other configurations, different structures are contemplated, such as a single opening, a snap or other coupling portion, as well as other structures to which a user attachment structure can be mated.

A back strap coupling assembly 162 is likewise positioned on the second side upstanding wall 34 proximate the upper edge 158 along the tail region. As with the front strap coupling assembly, a number of different structures are contemplated for use. In the configuration shown, again, much like the front strap coupling assembly, the back strap coupling assembly comprises a plurality of substantially circular openings that are configured to receive a fastener therethrough. It will be understood that depending on the configuration, the front and back strap coupling assemblies may be the same or different from each other.

It will be understood that the front strap coupling assembly 60 generally corresponds to the front strap coupling assembly 160 on opposing sides of the base 30. Similarly, the back strap coupling assembly 62 generally corresponds to the back strap coupling assembly 162 on opposing sides of base 30.

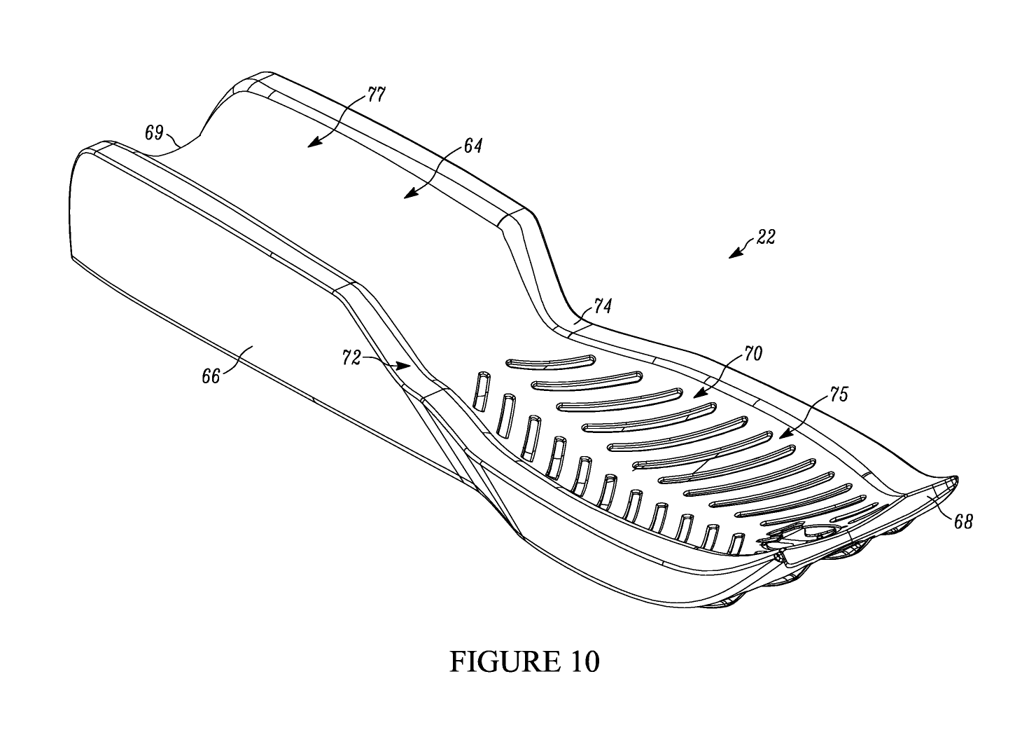

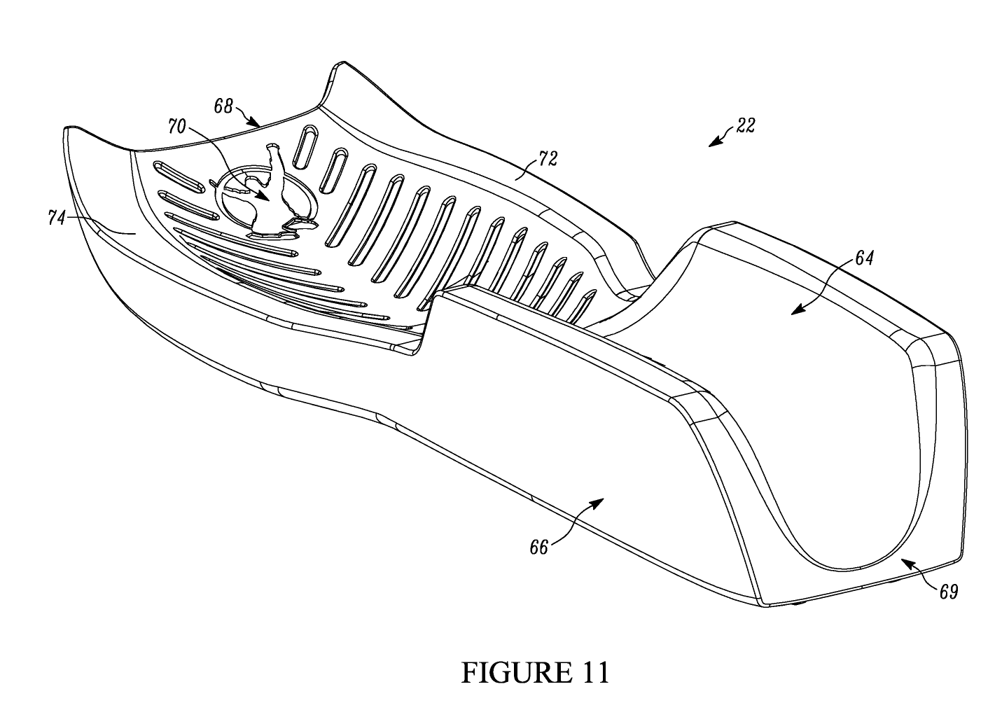

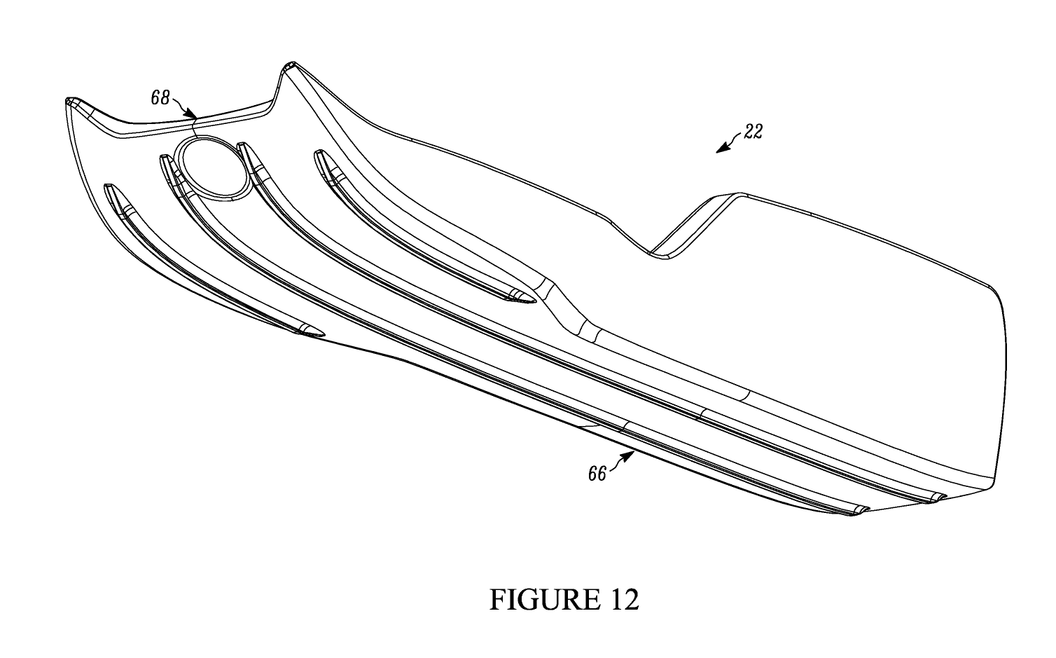

The inner sled pad 22 is shown in FIGS. 10 through 12 as comprising outward surface 64 and sled body facing surface 66. It will be understood that the inner sled pad 22 is positioned within the slot created by the sled body through the base 30 and the first and second side upstanding walls 32, 34. The inner sled pad generally comprises a foam based material, such as a urethane foam, for example, or other closed cell foam. It will be understood that the material may additionally comprise a self skinning closed cell foam, for example. In other configurations, the inner sled pad may comprise an outer shell (such as a vinyl container or the like) that has foam or other material positioned therewithin. In still other configurations, a fabric or other material may be utilized. Generally, the inner sled pad is provided to improve the comfort of the user by providing a relatively soft and compressible material that is softer than the sled body. In other configurations, the inner sled pad is insert molded in the outer sled body.

The sled body facing surface 66 follows the contours of the base 30 and the first and second side upstanding walls 32, 34. The sled body facing surface 66 may be coupled to the upper surface of the base through any number of different structures, including, but not limited to, adhesion, thermoforming, thermal adhesion, mechanical fastening through fasteners such as tabs, inserts, threaded fasteners, hook and loop fasteners and the like. Additionally, the two components may be coupled together through an interference fit or the like.

The outward surface 64 includes central portion 70 that has a forward region 75 and a tail region 77, again, following the contours of the base and upstanding walls. On either side of the central portion 70 are a first side ledge 72 and a second side ledge 74. A leading edge is defined at 68 and a tail end is defined at 69. The central portion 70 is configured to follow the contours of the leg of the user, what is generally known as the shin area of the user between the knee and the ankle area, and positioning the user in the desired position on the sled.

Due to the configuration of the outward surface relative to the base 30, the inner sled pad thickness varies along the length thereof. Generally, the thickness of the inner sled pad is greater on the tail region versus the forward region.

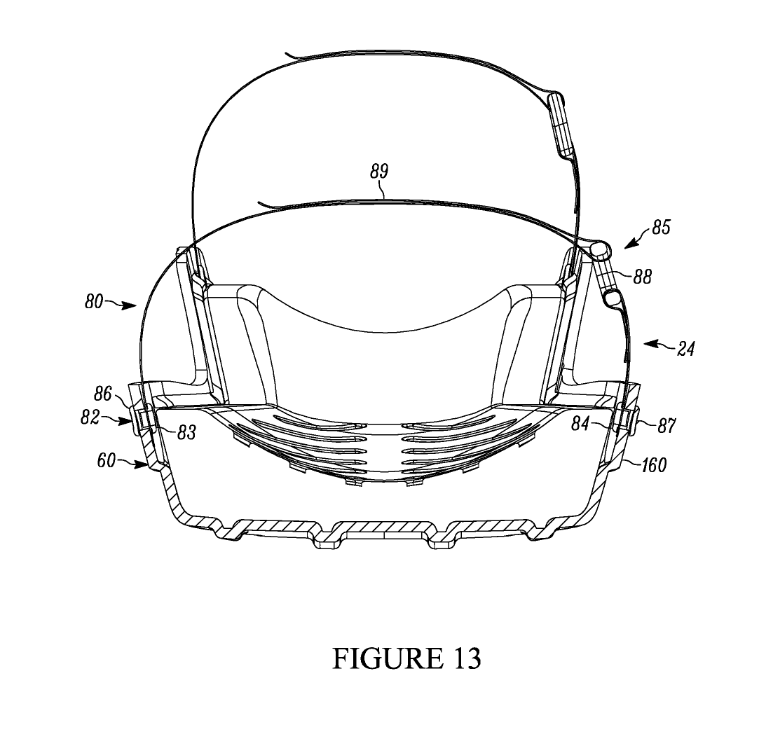

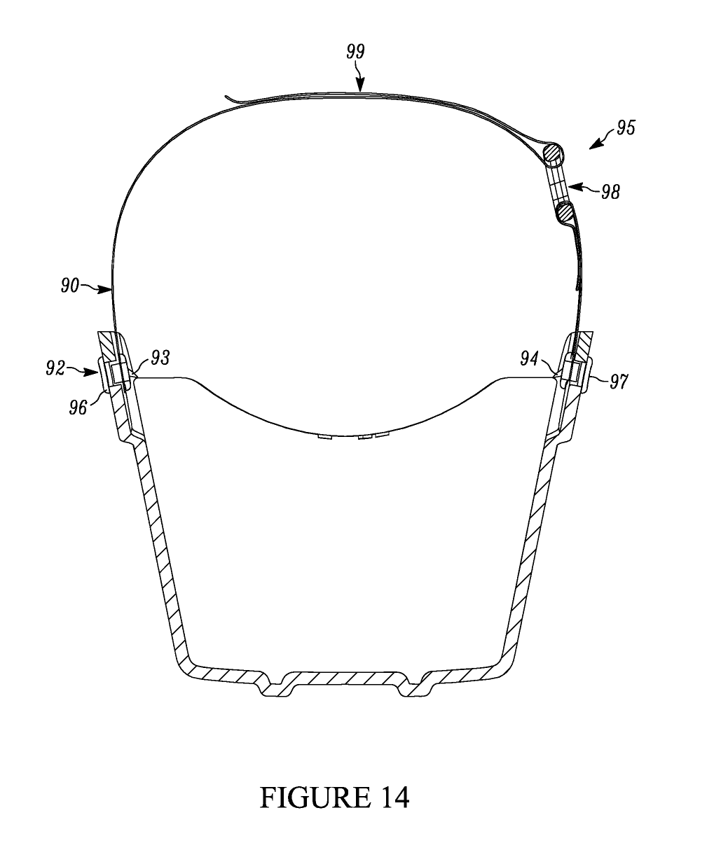

The user attachment structure 24 is shown in FIGS. 13 and 14 as comprising front strap 80, front strap body coupling 82, back strap 90 and back strap body coupling 92. In particular, the front strap includes first end 83, second end 84 and length adjustment structure 85. The length adjustment structure comprises ring 88 and hook and loop fastener 89. In the configuration shown, the front strap comprises two separate components that are joined together and adjusted relative to each other with the length adjustment structure 85. The front strap body coupling 82 includes first fastener 86 and second fastener 87. The first fastener couples the first end 83 to the front strap coupling assembly of the first side upstanding wall 32. The second fastener couples the second end 84 to the front strap coupling assembly of the second side upstanding wall 34.

Similarly, the back strap 90 includes first end 93, second end 94 and length adjustment structure 95. The length adjustment structure comprises ring 98 and hook and loop fastener 99. In the configuration shown, the back strap comprises two separate components that are joined together and adjusted relative to each other with the length adjustment structure 95. The back strap body coupling 92 comprises first fastener 96 and second fastener 97. The first fastener couples the first end 93 to the back strap coupling assembly of the first side upstanding wall 32. The second fastener couples the second end 94 to the back strap coupling assembly of the second side upstanding wall 34.

In other configurations, for either the front or the back portions of the user attachment structure a single strap may be utilized, wherein the single strap loops through openings on both of the first and second upstanding walls defining the respective front and back strap coupling assemblies. In still other configurations, opposing straps may be utilized which can be tied together through any number of different means, including, but not limited to buckles, snaps, buttons, zippers, ratcheting assemblies and the like. In other configurations, the straps may comprise woven material, molded material, fabrics, natural or synthetic materials or the like. In still further configurations, a fixed elastic member may be utilized as the user attachment structure, wherein such structure is generally fixed and wherein the elastic forces associated with the material maintain the position of the sled leg relative to the leg of the user. These structures may be mixed and matched for each of the front and back user attachment structures.

In other configurations, the sled legs can be formed with a closed volume, with the inner sled pad comprising a relative thin pad on the closed volume. In such a configuration, the inner sled pad can be minimized with the sled body forming a larger portion of the function of the inner sled pad, so as to take up the particular volume.

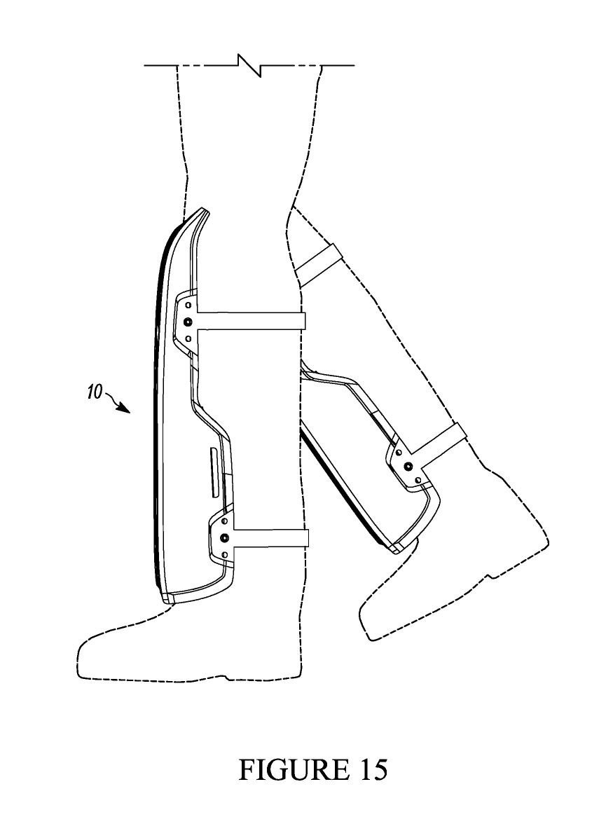

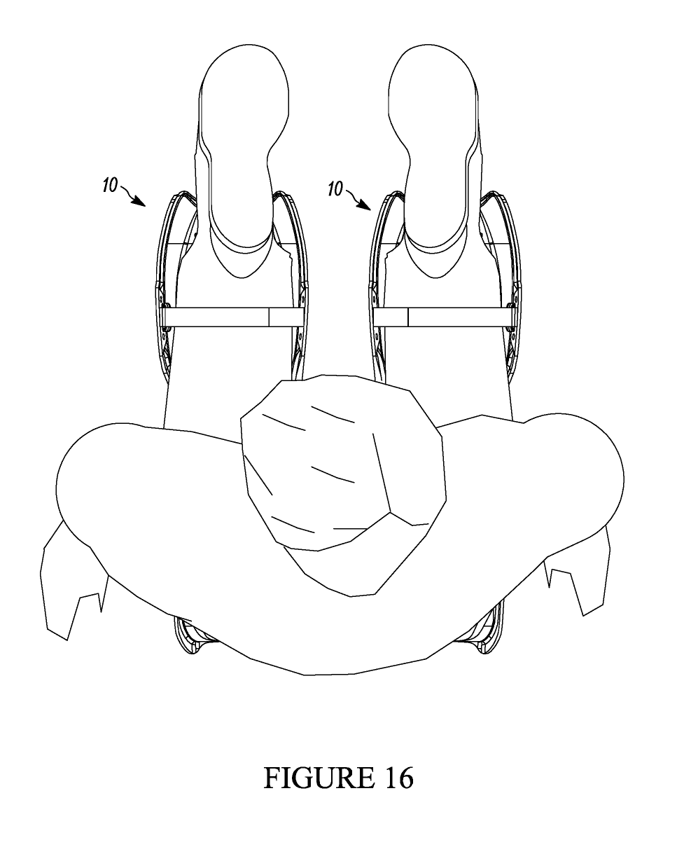

In operation, and with reference to FIGS. 15 and 16, the user straps one sled leg to one lower leg and the other sled leg to the other lower leg. This is accomplished by placing each lower leg onto the central portion 70 of the outward surface 64 of the inner sled pad 22 of each of the first and second sled legs, respectively. Once positioned, the user utilizes the user attachment structure to secure the leg to the sled leg by sandwiching the lower leg (i.e., shin) against the sled leg, and the leg essentially between the sled body and the user attachment structure. This is accomplished, in the configuration shown, by threading the respective strap through the respective length adjustment member. Once threaded therethrough, the user can adjust the length of the overall strap, and, in turn, the tension the strap places on the leg toward the inner sled pad. Once adjusted as desired, the user can utilize the hook and loop fastener to maintain the desired position.

Once both of the sled legs have been positioned, the user can walk or otherwise arrive at the sledding hill. Advantageously, and as is shown in FIG. 15, the user can easily walk with the sled legs coupled to the user. That is, the sled legs do not interfere with walking, and do not impede the operation of the knee and ankle joints of the user, nor do the structures otherwise negatively impact walking. When the user reaches the starting point of the hill, as is shown in FIG. 16, the user kneels down so as to place the lower surface of the base 30 of the sled body 20 onto the outside surface (i.e., the snow or other surface of relatively low friction, which may include other lower friction surfaces on hills, mountains, valleys, on snow, mud or grass, as well as on water). The user can initiate forward movement, and, can also lift the toes from the ground (if the toes are touching the ground when kneeling), and the user can begin to slide down the hill on the sled legs. The user can shift his or her weight and body to direct the sled from side to side and to turn. The user can also utilize his or her hands or feet to initiate a change in direction or to slow down.

Once the user reaches the bottom, or otherwise is done sledding, the user can merely stand up and begin walking. Again, the sled legs remain in operable position, ready for immediate use, without negatively affecting the ability of the user to walk.

It is further contemplated that the sled legs can be coupled together, for example, through the openings of the upstanding portions so that the overall coupled device can be used as a conventional sled, wherein the user sits on the coupled sled legs and slides down a surface of relatively low friction. In other configurations, openings or handles may be provided on the sled legs so as to allow one to carry the same. In still other configurations, a rope can be extended through openings on the sled legs to allow for a user to tow or carry the sled legs over the shoulder.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A sled leg for a snow sled leg apparatus comprising:
a sled body having a base with an upper surface and a lower surface opposite the upper surface, and a nose and a tail, with the nose including an upwardly inclined portion, the lower surface structurally configured to slide along an outside surface of relatively low friction, and the upper surface structurally configured to receive a shin of a user thereover;
a user attachment structure extending from opposing sides of the sled body, the user attachment structure structurally configured to sandwich a leg of a user between the user attachment structure and the sled body, to, in turn, maintain the sled body in a desired position.

2. The sled leg of claim 1 wherein the sled body further includes a first side upstanding wall and a second side upstanding wall spaced apart from the first side upstanding wall, each of the first and second side upstanding walls extending between the nose and the tail of the base so as to define a channel, with the user attachment structure interfacing at a first end with the first side upstanding wall and at a second end with the second side upstanding wall.

3. The sled leg of claim 2 wherein the sled body includes a front strap coupling assembly and a back strap coupling assembly, and wherein the user attachment structure comprises a front strap coupled to the front strap coupling assembly and a back strap coupled to the back strap coupling assembly.

4. The sled leg of claim 3 wherein the front strap coupling assembly comprises a plurality of openings on the first side upstanding wall which correspond to a plurality of openings on the second side upstanding wall.

5. The sled leg of claim 4 wherein the front strap includes a first end coupled to the front strap coupling assembly through a first fastener and a second end coupled to the front strap coupling assembly through a second fastener, and wherein the front strap includes a length adjustment structure.

6. The sled leg of claim 4 wherein the back strap coupling assembly comprises a plurality of openings on the first side upstanding wall which correspond to a plurality of openings on the second side upstanding wall, with the front strap coupling assembly being spaced apart from the back strap coupling assembly.

7. The sled leg of claim 2 wherein the lower surface of the base includes a plurality of ridges that extend generally parallel to the channel and between the nose and tail thereof.

8. The sled leg of claim 2 further comprising an inner sled pad positioned within the channel of the sled body, the inner sled pad including an outward surface structurally configured to receive the shin of the user and a sled body facing surface overlying the inner surface of the base and an inner surface of each of the first side upstanding wall and second side upstanding wall.

9. The sled leg of claim 8 wherein the inner sled pad is one of adhered, thermally bonded and mechanically fastened to the sled body.

10. The sled leg of claim 8 wherein the inner sled pad is softer than the sled body.

11. The sled leg of claim 8 wherein the outward surface of the inner sled pad includes a central portion, with a first side ledge to one side thereof and a second side ledge to a second side thereof.

12. The sled leg of claim 8 including a forward region proximate the nose and a tail region proximate the tail, the forward region and the tail region meeting between the nose and the tail, with the forward region being thinner than the tail region.

13. The sled leg of claim 12 wherein the forward region is wider than the tail region.

14. The sled leg of claim 10 wherein the inner sled pad comprises a closed cell foam.

15. A snow sled leg apparatus comprising a pair of sled legs, each sled leg comprising:
a sled body having a base with an upper surface and a lower surface opposite the upper surface, and a nose and a tail, with the nose including an upwardly inclined portion, the lower surface structurally configured to slide along an outside surface of relatively low friction, a first side upstanding wall and a second side upstanding wall on either side of the base extending upwardly from the upper surface of the base and the upper surface structurally configured to receive a shin of a user thereover;
an inner sled pad positioned within the channel of the sled body, the inner sled pad including an outward surface structurally configured to receive the shin of the user and a sled body facing surface overlying the inner surface of the base and an inner surface of each of the first side upstanding wall and second side upstanding wall; and
a user attachment structure extending from opposing sides of the sled body, the user attachment structure structurally configured to sandwich a leg of a user between the user attachment structure and the sled body, to, in turn, maintain the sled body in the desired position.

16. A method of using a snow sled leg apparatus comprising the steps of:
providing a first sled leg and a second sled leg, each sled leg having a sled body and a user attachment structure coupled to the sled body;
positioning a first lower leg of a user over an upper surface of the sled body of the first sled leg;
sandwiching the first lower leg of a user between the sled body and the user attachment structure of the first sled leg to releasably couple the first lower leg thereto;
positioning a second lower leg of the user over an upper surface of the sled body of the second sled leg, thereby placing the same in an operable configuration;
sandwiching the second lower leg of a user between the sled body and the user attachment structure of the second sled leg to releasably couple the second lower leg thereto, thereby placing the same in an operable configuration;
kneeling on an outside surface of relatively low friction so as to place a lower surface of the sled body of each of the first and second sled legs on the outside surface; and
sliding along the outside surface on the lower surface of the sled body of each of the first and second sled legs.

17. The method of claim 16 further comprising the step of:
standing up after the step of sliding; and
walking while maintaining the first sled leg and the second sled leg in the operable configuration.

18. The method of claim 17 wherein the first sled leg and the second sled leg do not interfere with either the knee or the ankle when in the operable configuration.

19. The method of claim 17 wherein the step of sliding further comprises the step of:
shifting weight of the user to effectuate a change in direction while sliding.
